(19) United States
(12) Patent Application Publication
(10) Pub. No.: US 2026/0358550 A1
(43) Pub. Date: Nov. 12, 2026

(54) DISPLAY DEVICE

(71) Applicant: LG ELECTRONICS INC., Seoul (KR)

(72) Inventor: Youngmin KIM, Seoul (KR)

(73) Assignee: LG ELECTRONICS INC., Seoul (KR)

(21) Appl. No.: 19/139,116

(22) PCT Filed: Dec. 16, 2022
(86) PCT No.: PCT/KR2022/020649

§ 371 Date: Jun. 13, 2025

(30) Foreign Application Priority Data
Dec. 13, 2022 (KR) 10-2022-0173686

(51) Int. Cl. F21V 8/00

(52) U.S. Cl. CPC G02B 6/0083; G02B 6/0086

(57) ABSTRACT

A display device is disclosed. The display device of the present disclosure may comprise: a display panel; a light guide plate located at the rear of the display panel; an optical assembly for providing light to one side of the light guide plate; a substrate on which the optical assembly is mounted; and a rear part disposed at the rear surface of the light guide plate; and a heat dissipation plate comprising a side part which is bent forward from one side of the rear part to cover one side of the light guide plate and to which the substrate is coupled, wherein the heat dissipation plate may comprise heat dissipation fins protruding rearward from the rear part.

### TECHNICAL FIELD

The present disclosure relates to a display device.

### BACKGROUND ART

With the development of information society, there has been a growing demand for various types of display devices. In order to meet such demand, various display devices, such as a liquid crystal display (LCD) device, a plasma display panel (PDP), an electro luminescent display (ELD), a vacuum fluorescent display (VFD), an organic light emitting diode (OLED) display, and the like, have been developed and used.

Among them, an LCD panel includes a TFT substrate and a color substrate that are opposite each other with a liquid crystal layer interposed therebetween, and can display an image using light provided from a backlight unit.

Recently, as interest in heat dissipation components and materials that effectively dissipate heat generated from the internal devices of a display device has increased, numerous research has been conducted to improve heat dissipation performance.

### DETAILED DESCRIPTION OF INVENTION

### Technical Problems

It is an object of the present disclosure to solve the above and other problems.

It may be another object of the present disclosure to effectively dissipate heat generated from a light source.

It may be another object of the present disclosure to effectively dissipate heat from other heat-generating components.

### Technical Solution

In accordance with an aspect of the present disclosure, the above and other objects can be accomplished by providing a display device including: a display panel; a light guide plate positioned behind the display panel; a light assembly configured to provide light to one side of the light guide plate; a substrate on which the light assembly is mounted; and a heat dissipation plate including a rear part that is disposed on a rear surface of the light guide plate, and a side part that is bent forward from one side of the rear part to cover one side of the light guide plate and to which the substrate is coupled, wherein the heat dissipation plate includes a heat dissipation fin protruding rearward from the rear part.

### Effect of Invention

A display device according to the present disclosure has the following effects.

According to at least one of the embodiments of the present disclosure, it is possible to effectively dissipate heat generated from a light source.

According to at least one of the embodiments of the present disclosure, it is possible to effectively dissipate heat from other heat-generating components.

### BRIEF DESCRIPTION OF THE DRAWING

FIGS. 1 to 20 are diagrams illustrating examples of a display device according to embodiments of the present disclosure.

### MODE FOR CARRYING OUT THE INVENTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand various technical features and it should be understood that the embodiments disclosed herein are not limited by the accompanying drawings. As such, the present disclosure should be construed to extend to any alterations, equivalents, and substitutes in addition to those which are particularly set out in the accompanying drawings.

Although the terms “first”, “second”, etc. may be used herein to describe various elements, these elements should not be limited by these terms. These terms are only used to distinguish one element from another.

It will be understood that when a component is referred to as being “coupled” or “connected” to another component, it may be directly coupled or connected to another component, or intervening components may be present. In contrast, when a component is referred to as being “directly coupled” or “directly connected” to another component, there are no intervening components present.

A singular representation may include a plural representation unless the context clearly indicates otherwise.

Terms such as “comprises or includes” or “has” are used herein and should be understood that they are intended to indicate an existence of features, numbers, steps, operations, elements, components, or combinations thereof, disclosed in the specification, but do not preclude the presence or addition of one or more other features, numbers, steps, operations, elements, components, or combinations thereof.

The directions “up (U)”, “down (D)”, “left (Le)”, “right (Ri)”, “front (F)”, and “rear (R)” shown in the drawings are used only for convenience of description, and the technical concept disclosed in this specification is not limited by these directions.

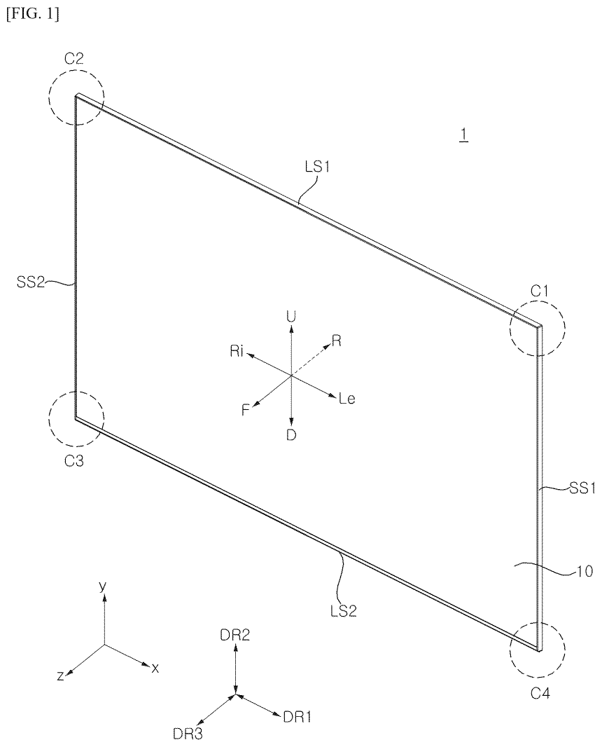

Referring to FIG. 1, a display device 1 may include a display panel 10. The display panel 10 may display a screen.

The display device 1 may include a first long side LS1, a second long side LS2 opposite the first long side LS1, a first short side SS1 adjacent to the first long side LS1 and the second long side LS2, and a second short side SS2 opposite the first short side SS1. For ease of explanation, it is illustrated and described that lengths of the first and second long sides LS1 and LS2 are greater than lengths of the first and second short sides SS1 and SS2. However, the lengths of the first and second long sides LS1 and LS2 may be substantially equal to the lengths of the first and second short sides SS1 and SS2.

A direction parallel to the long sides LS1 and LS2 of the display device 1 may be referred to as a left-right direction or a first direction DR1. A direction parallel to the short sides SS1 and SS2 of the display device 1 may be referred to as an up-down direction or a second direction DR2. A direction perpendicular to the long sides LS1 and LS2 and the short sides SS1 and SS2 of the display device 1 may be referred to as a front-rear direction or a third direction DR3.

A direction in which the display panel 10 displays an image may be referred to as a front (F, z), and a direction opposite to the front may be referred to as a rear (R). The first long side LS1 may be referred to as an upper side (U, y). The second long side LS2 may be referred to as a lower side (D). The first short side SS1 may be referred to as a left side (Le, x). The second short side SS2 may be referred to as a right side (Ri).

The first long side LS1, the second long side LS2, the first short side SS1, and the second short side SS2 may be referred to as edges of the display device 1. In addition, points where the first long side LS1, the second long side LS2, the first short side SS1, and the second short side SS2 meet one another may be referred to as corners.

For example, a point where the first short side SS1 and the first long side LS1 meet may be referred to as a first corner C1; a point where the first long side LS1 and the second short side SS2 meet may be referred to as a second corner C2; a point where the second short side SS2 and the second long side LS2 meet may be referred to as a third corner C3; and a point where the second long side LS2 and the first short side SS1 meet may be referred to as a fourth corner C4.

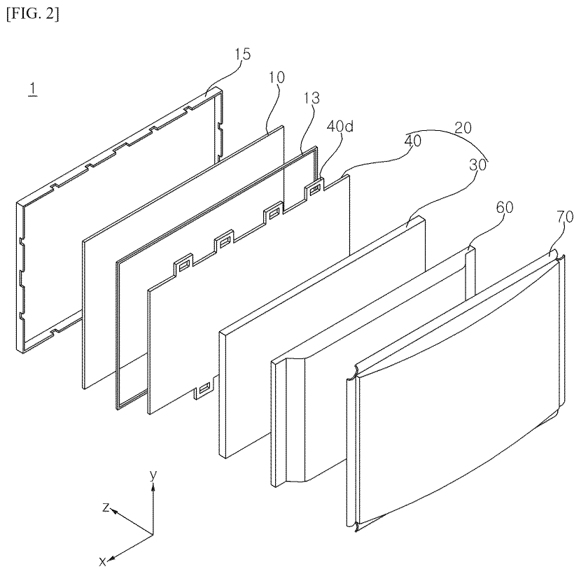

Referring to FIG. 2, the display device 1 may include a display panel 10, a front cover 15, a guide panel 13, a backlight unit 20, a frame 60, and a back cover 70.

The display panel 10 may define the front surface of the display device 1 and may display an image. The display panel 10 may display an image in such a manner that each of a plurality of pixels outputs red, green or blue (RGB) light in accordance with timing. The display panel 10 may be divided into an active area in which an image is displayed and a de-active area in which no image is displayed. The display panel 10 may include a front substrate and a rear substrate that are opposite each other with a liquid crystal layer interposed therebetween. The display panel 10 may be referred to as an LCD panel.

The front substrate may include a plurality of pixels, each of which consists of red, green, and blue sub-pixels. The front substate may output light corresponding to red, green or blue color in response to a control signal.

The rear substrate may include switching elements. The rear substrate may switch a pixel electrode. For example, the pixel electrode may change the molecular arrangement of a liquid crystal layer in response to a control signal input from the outside. The liquid crystal layer may include liquid crystal molecules. The arrangement of the liquid crystal molecules may be changed according to a voltage difference between the pixel electrode and a common electrode. The liquid crystal layer may transmit light provided from the backlight unit 20 to the front substrate or block the light.

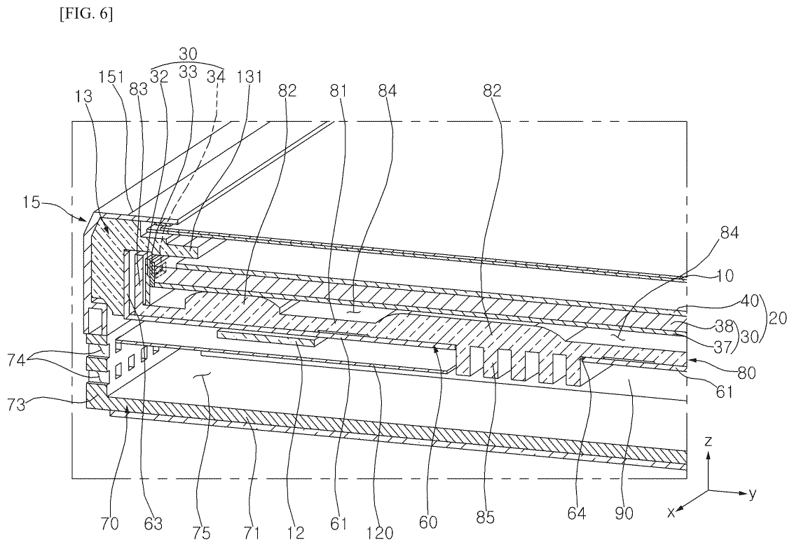

The front cover 15 may surround a periphery of the display panel 10, and may cover at least a partial area of the front and lateral surfaces of the display panel 10. The front cover 15 may extend along the periphery of the display panel 10. The front cover 15 may be divided into a first part 153 (see FIG. 6) positioned at the front surface of the display panel 10 and a second part 151 (see FIG. 6) positioned at the lateral surface of the display panel 10. The first part 153 and the second part 151 may be provided separately or may be provided as one body. At least one of the first part 153 and the second part 151 may be omitted. The front cover 15 may be referred to as a case top.

The guide panel 13 may surround the periphery of the display panel 10, and may cover at least a partial area of the rear and lateral surfaces of the display panel 10. The guide panel 13 may be coupled to the display panel 10 or may support the display panel 10. The guide panel 13 may be referred to as a panel guide or a side frame.

The backlight unit 20 may be positioned at the rear of the display panel 10. The backlight unit 20 may include light sources. The backlight unit 20 may be coupled to the frame 60 at the front of the frame 60. The backlight unit 20 may be driven by a full driving scheme or a partial driving scheme such as local dimming or impulsive driving. The backlight unit 20 may include an optical sheet 40 and an optical layer 30.

The optical sheet 40 may allow light from the light source to be uniformly transmitted to the display panel 10. The optical sheet 40 may consist of a plurality of layers. For example, the optical sheet 40 may include a prism sheet, a diffusion sheet, or the like. For example, the optical sheet 40 may be a double brightness enhancement film (DBEF). Meanwhile, a coupling portion 40d of the optical sheet 40 may be coupled to the front cover 15, the frame 60, or the back cover 70.

The frame 60 may be positioned at the rear of the backlight unit 20, and may support some components of the display device 1. For example, the backlight unit 20, a printed circuit board (PCB) on which a plurality of electronic elements are mounted, and the like may be coupled to the frame 60. The frame 60 may include a metal material such as an aluminum alloy. The frame 60 may be referred to as a main frame or a module cover.

The back cover 70 may cover the rear of the frame 60. The back cover 70 may be coupled to the frame 60 and/or the front cover 15. For example, the back cover 70 may be an injection-molded resin part. As another example, the back cover 70 may include a metal material.

Meanwhile, a cable (not shown) may be electrically connected to the display panel 10 and a source PCB (not shown). The source PCB may be positioned at the rear of the frame 60.

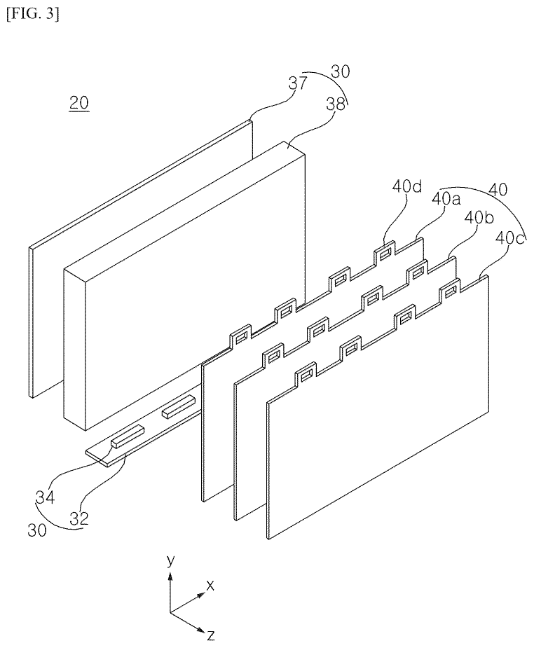

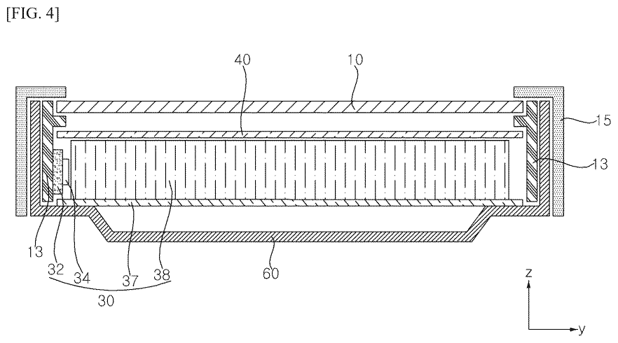

Referring to FIGS. 3 and 4, the backlight unit 20 may include an optical layer 30 and an optical sheet 40. The optical layer 30 may be positioned between the frame 60 and the display panel 10. The optical layer 30 may be supported by the frame 60. The optical layer 30 may include a substrate 32, at least one light source 34, a reflective sheet 37, and a light guide plate 38.

The light guide plate 38 may be positioned between the frame 60 and the optical sheet 40, and may be supported by the frame 60. The light guide plate 38 may be referred to as an optical plate 38.

The substrate 32 may be adjacent to a periphery of the light guide plate 38, and may be coupled to one side of the guide panel 13. For example, the substrate 32 may be adjacent to a lower side of the light guide plate 38. The substrate 32 may be made of at least one of polyethylene terephthalate (PET), glass, polycarbonate (PC), or silicon. The substrate 32 may be a printed circuit board (PCB).

At least one light source 34 may be mounted on the substrate 32. A plurality of light sources 34 may be spaced apart from each other on the substrate 32. An electrode pattern for connecting an adapter and the light source 34 may be formed on the substrate 32. For example, a carbon nanotube (CNT) electrode pattern may be formed on the substrate 34 to connect the light source 34 and the adapter.

For example, the light source 34 may be a light emitting diode (LED) chip or an LED package including at least one LED chip. The light source 34 may consist of a colored LED that emits at least one of red, green or blue light, or a white LED. The colored LED may include at least one of a red LED, a green LED, or a blue LED. The light source 34 may be referred to as a light assembly 34.

The reflective sheet 37 may be positioned between the frame 60 and the light guide plate 38, and may be supported by the frame 60. The reflective sheet 37 may include at least one of a metal or a metal oxide as a reflective material. For example, the reflective sheet 37 may include a metal and/or a metal oxide having a high reflectance such as at least one of aluminum (Al), silver (Ag), gold (Au), or titanium dioxide (TiO2).

Accordingly, the light source 34 may provide light to an edge of the light guide plate 38. The light entering the light guide plate 38 may be directed forward by the light guide plate 38 and the reflective sheet 37.

The optical sheet 40 may be positioned at the front of the light guide plate 38. A rear surface of the optical sheet 40 may be in close contact with the light guide plate 38, and a front surface of the optical sheet 40 may be in close contact with or adjacent to the rear surface of the display panel 10. The optical sheet 40 may include at least one sheet.

For example, the optical sheet 40 may include a plurality of sheets having different functions. A first optical sheet 40a may be a diffusion sheet, and a second optical sheet 40b and a third optical sheet 40c may be prism sheets. The diffusion sheet may prevent light from the light guide plate 38 from being partially concentrated, thereby achieving more uniform distribution of light. The prism sheet may collect light from the light guide plate 38 and provide the light to the display panel 10. Meanwhile, the diffusion sheet and the prism sheet may vary in number and/or position.

A coupling portion 40d may be formed on at least one edge of the optical sheet 40. The coupling portion 40d may be formed on at least one of the first optical sheet 40a, the second optical sheet 40b, or the third optical sheet 40c.

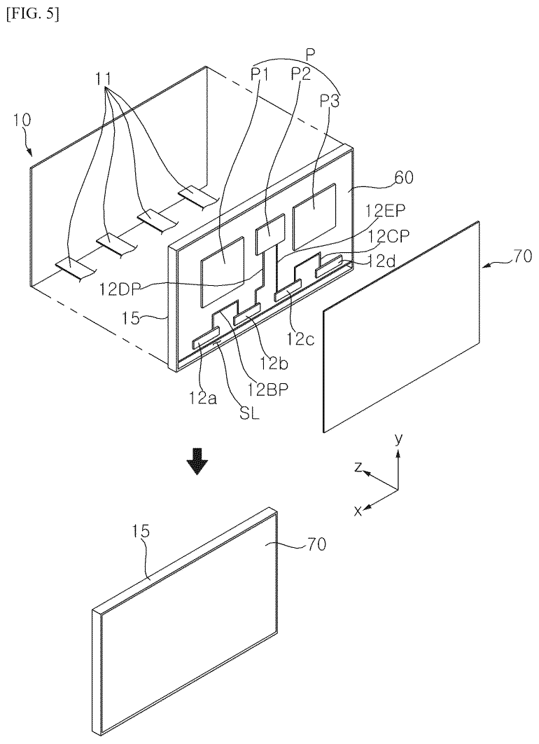

Referring to FIG. 5, a board P and a source PCB (12a, 12b, 12c, 12d) may be mounted on a rear surface of the frame 60. A plurality of electronic elements may be mounted on the board P. The board P may be a printed circuit board (PCB), and may be electrically connected to electronic components of the display device. Meanwhile, the board P and the source PCB (12a, 12b, 12c, 12d) may be mounted on a front surface of the frame 60.

A plurality of boards P1, P2, and P3 may be mounted on the rear surface of the frame 60. A power supply board PI may supply power to each component of the display device. A timing controller board P2 may provide an image (or video) signal to the display panel 10. A main board P3 may control each component of the display device. For example, the power supply board Pl may be adjacent to a left side of the frame 60, the main board P3 may be adjacent to a right side of the frame 60, and the timing controller board P2 may be positioned between the power supply board Pl and the main board P3.

A first cable 11 may be adjacent to a lower side of the display panel 10, and may be electrically connected to the display panel 10. The first cable 11 may pass through a slit SL provided on a lower side of the frame 60. Alternatively, the first cable 11 may pass through a cable hole (not shown) formed in the frame 60. For example, the first cable 11 may be a chip on film (COF).

The source PCB (12a, 12b, 12c, 12d) may be adjacent to the lower side of the display panel 10, and may be coupled to the rear surface of the display panel 10. The source PCB (12a, 12b, 12c, 12d) may be referred to as an S-PCB (12a, 12b, 12c, 12d). The source PCB (12a, 12b, 12c, 12d) may be electrically connected to the first cable 11. For example, a plurality of source PCBs 12a, 12b, 12c, and 12d may be spaced apart from each other along the lower side of the display panel 10, and may be electrically connected to a plurality of first cables 11.

A second cable (12BP, 12CP, 12DP, 12EP) may be positioned at the rear of the frame 60, and may be electrically connected to the source PCB (12a, 12b, 12c, 12d) and the timing controller board P2. A first bridge cable 12BP may provide an electrical connection between a first source PCB 12a and a second source PCB 12b, and a second bridge cable 12CP may provide an electrical connection between a third source PCB 12c and a fourth source PCB 12d. A first connecting cable 12DP may provide an electrical connection between the second source PCB 12b and the timing controller board P2, and a second connecting cable 12EP may provide an electrical connection between the third source PCB 12c and the timing controller board P2. For example, the second cable (12BP, 12CP, 12DP, 12EP) may be a flexible flat cable (FFC). Meanwhile, the timing controller board P2 may be integrated into the main board P3, and in this case, the second cable (12BP, 12CP, 12DP, 12EP) may be electrically connected to the main board P3.

Accordingly, the timing controller board P2 or the main board P3 may provide digital video data and timing control signals to the display panel 10 through the source PCB (12a, 12b, 12c, 12d).

The back cover 70 may be positioned at the rear of the frame 60, and may be coupled to the frame 60. The board P may be positioned between the frame 60 and the back cover 70, and may be covered by the back cover 70.

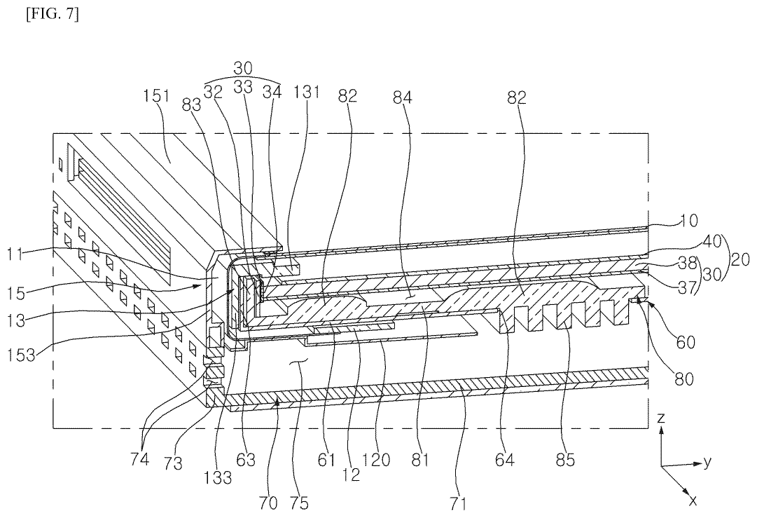

Referring to FIGS. 6 and 7, the frame 60 may include a plate portion 61 and a bending portion 63. The plate portion 61 may form the front surface of the frame 60, and may be formed generally flat. The bending portion 63 may be bent forward from a periphery of the plate portion 61 and extend along the periphery of the plate portion 61.

The guide panel 13 may include a horizontal portion 131 and a vertical portion 133. The vertical portion 133 may extend along the bending portion 63, and may cover an outside of the bending portion 63. The horizontal portion 131 may intersect the vertical portion 133, and may cover a portion of the front of the frame 60 and the light guide plate 38. The horizontal portion 131 may cover a portion of the periphery and rear of the display panel 10.

The front cover 15 may include a first part 153 and a second part 151. The first part 153 may extend along the vertical portion 133, and may cover an outside of the vertical portion 133. The second part 151 may intersect the first part 153, and may cover a portion of the periphery and front of the guide panel 13 and the display panel 10. The periphery and portions of the front and rear adjacent to the periphery of the display panel 10 may be coupled or adhered to the horizontal portion 131 and the second part 151.

The back cover 70 may be positioned at the rear of the frame 60, and may be coupled to the frame 60. The back cover 70 may include a rear cover 71 and a side cover 73. The rear cover 71 may form a front surface of the back cover 70, and may be generally flat in shape. The side cover 73 may be bent forward from a periphery of the rear cover 71 and extend along the periphery of the rear cover 71. The side cover 73 may be disposed at the rear of the front cover 15.

The back cover 70 may cover the rear of the frame 60. A heat dissipation space (or passage) 75 may be formed between the back cover 70 and the frame 60. The heat dissipation space 75 may be formed between the rear cover 71, the side cover 73, and the plate portion 61 of the frame 60.

A heat dissipation hole 74 may be formed in the side cover 73. For example, the heat dissipation hole 74 may be formed in the side cover 73 on the lower side. The heat dissipation hole 74 may communicate with the heat dissipation space 75.

The display device 1 may include a heat dissipation plate 80. The heat dissipation plate 80 may be disposed between the backlight unit 20 and the frame 60. The heat dissipation plate 80 may cover the rear and one side of the backlight unit 20. A rear surface of the heat dissipation plate 80 may be in contact with the front surface of the frame 60. The heat dissipation plate 80 may be adjacent to the lower side of the frame 60.

The heat dissipation plate 80 may include a rear part 81. The rear part 81 may be positioned at the rear of the light guide plate 38 and the reflective sheet 37. The rear part 81 may be positioned on the plate portion 61. A rear surface of the rear part 81 may be in contact with a front surface of the plate portion 61. The heat dissipation plate 80 may include a protruding portion 82. The protruding portion 82 may protrude forward from a front surface of the rear part 81.

The heat dissipation plate 80 may include a side part 83. The side part 83 may be bent from a lower side of the rear part 81 between the bending portion 63 and the protruding portion 82. The side part 83 may cover the lower side of the light guide plate 38.

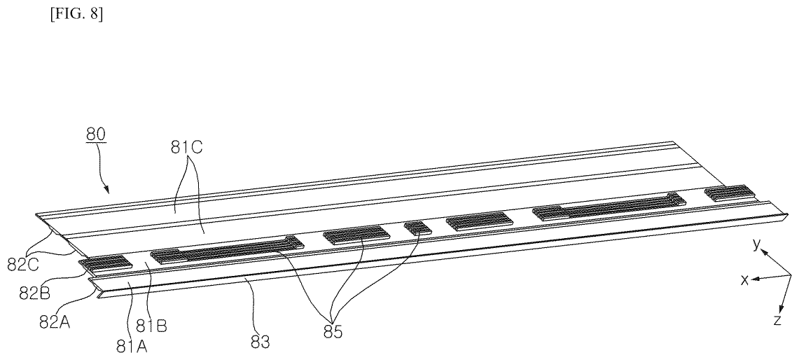

Referring also to FIG. 8, the heat dissipation plate 80 may be elongated in the left-right direction. The rear part 81 may be elongated in the left-right direction. The protruding portion 82 may be elongated in the left-right direction. The protruding portion 82 may be provided in plurality. The plurality of protruding portions 82 may be arranged to be spaced apart from each other in the up-down direction. Front surfaces of the plurality of protruding portions 82 may support a rear surface of the backlight unit 20. The plurality of protruding portions 82 may separate the rear surface of the backlight unit 20 from the front surface of the rear part 81 in the front-rear direction to thereby form a space 84.

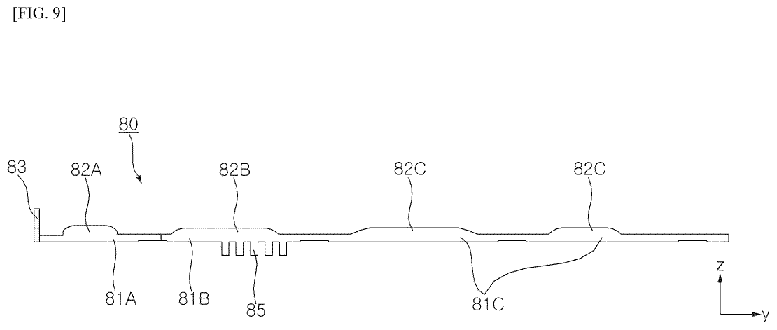

Referring also to FIG. 9, the side part 83 may be bent and extend forward from one edge of the rear part 81. For example, the side part 83 may be bent and protrude forward from the lower side of the rear part 81. The side part 83 may protrude further forward than the protruding portion 82.

The rear part 81 may be divided into a first rear part 81A, a second rear part 81B, and a third rear part 81C sequentially from the bottom to the top. The protruding portion 82 may be divided into a first protruding portion 82A protruding from the first rear part 81A, a second protruding portion 82B protruding from the second rear part 81B, and a third protruding portion 82C protruding from the third rear part 81C. The side part 83 may be bent forward from a lower end of the first rear part 81 A.

The light guide plate 38 may be positioned between the horizontal portion 131 and the protruding portion 82. The reflective sheet 37 may be coupled to a rear surface of the light guide plate 38, and may be positioned on the protruding portion 82. The optical sheet 40 may be positioned at the front of the light guide plate 38.

Accordingly, a lower portion of the light guide plate 38 may be supported by the protruding portion 82, and the remaining portion of the light guide plate 38 may be supported by the plate portion 61.

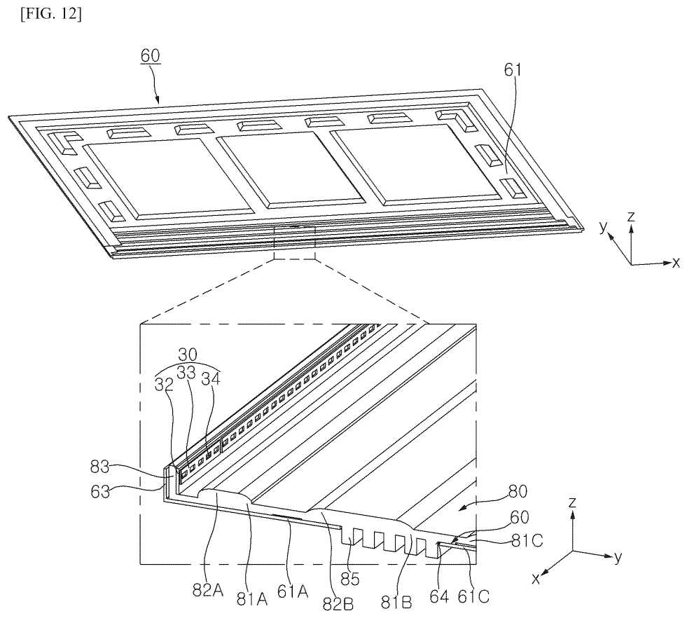

The substrate 32 may be positioned between the light guide plate 38 and the side part 83. The substrate 32 may be positioned between the side part 83 and the protruding portion 82. The substrate 32 may be coupled to the side part 83. The substrate 32 may extend in the left-right direction along one side of the light guide plate 38 (refer to FIG. 12). The side part 83 and the rear part 81 may be elongated laterally along a longitudinal direction of the substrate 32 (refer to FIG. 12).

A guard 33 may be disposed between the substrate 32 and the protruding portion 82, and may be positioned on the substrate 32. The guard 33 may be positioned on an area of the substrate 32 other than an area where the light source 34 is provided. The guard 33 may have a hole in which the light source 34 is positioned. The guard 33 may be an injection-molded part made of resin or silicone. The guard 33 may have a thickness greater than a thickness of the light source 34, and may prevent collision between the light guide plate 38 and the light source 34.

In this case, the light source 34 may face the lower side of the light guide plate 38. The light source 34 may be operated by receiving power from a power device (not shown) through the substrate 32. Accordingly, light from the light source 34 may be provided to the lower side of the light guide plate 38. The light incident on the light guide plate 38 may be directed forward by the light guide plate 38 and the reflective sheet 37.

The heat dissipation plate 80 may receive heat generated from the substrate 32 and dissipate the heat to the outside. The heat dissipation plate 80 may include a metal material such as aluminum (Al). The heat dissipation plate 80 may be referred to as a heat sink.

The heat dissipation plate 80 may further include a heat dissipation fin 85. The heat dissipation fin 85 may protrude from the heat dissipation plate 80. For example, the heat dissipation fin 85 may protrude rearward from the rear part 81. The heat dissipation fin 85 may conduct heat from the rear part 81. The heat dissipation fin 85 may increase the heat radiating surface of the heat dissipation plate 80. A plurality of fins formed on the heat dissipation fin 85 may extend in the left-right direction, and may be spaced apart from each other in the up-down direction.

The heat dissipation fin 85 may be exposed to the heat dissipation space 75 by passing through a first slit 64 formed in the plate portion 61. The first slit 64 may have a shape that is elongated in the left-right direction corresponding to the heat dissipation fin 85. The heat dissipation hole 74 may be open in the up-down direction so as to face the heat dissipation fin 85. Air may circulate in and out of the heat dissipation space 75 through the heat dissipation hole 74, thereby exchanging heat with the rear part 81, the plate portion 71, and the heat dissipation fin 85. Accordingly, heat generated from the substrate 32 may be conducted to the side part 83 and the rear part 81 and then be effectively dissipated through the heat dissipation fin 85.

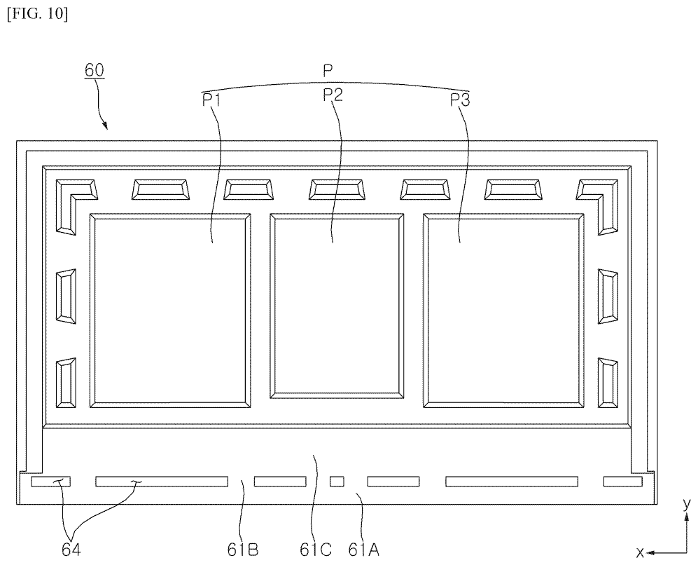

Referring also to FIG. 8 and FIG. 10, the heat dissipation plate 80 may have a plurality of heat dissipation fins 85. The plurality of heat dissipation fins 85 may be arranged to be spaced apart from each other in the left-right direction, thereby further increasing the heat dissipation area. The plate portion 61 may have a plurality of first slits 64. The plurality of first slits 64 may be arranged to be spaced apart from each other in the left-right direction. Each of the plurality of first slits 64 may correspond to a respective one of the plurality of heat dissipation fins 85.

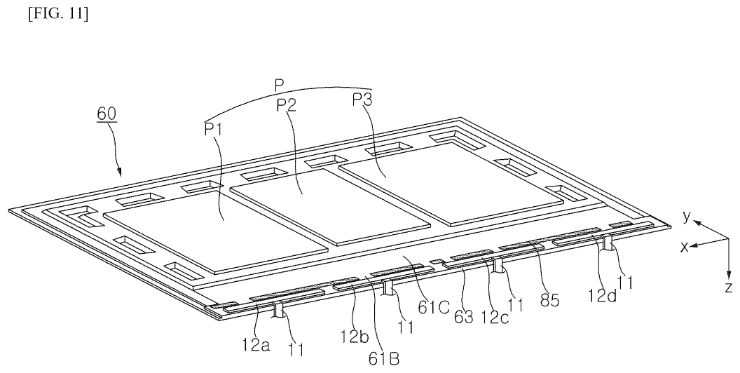

Referring also to FIGS. 11 and 12, each of the plurality of heat dissipation fins 85 may protrude rearward from the rear part 81 and pass through a respective one of the plurality of first slits 64 formed in the plate portion 61. As another example, the first slit 64 may be formed as a single slit with a shape that is elongated in the left-right direction to allow the plurality of heat dissipation fins 85 to pass through. The heat dissipation fin 85 may be disposed above the source PCB 12.

Referring also to FIG. 12, the substrate 32 may extend along one side of the light guide plate 38. For example, the substrate 32 may be elongated in the left-right direction. The substrate 32 may extend along the side part 83. A plurality of light sources 34 may be positioned between the substrate 32 and the protruding portion 82, and may be mounted on the substrate 32. The plurality of light sources 34 may be spaced apart from each other in the longitudinal direction of the substrate 32, namely, in the left-right direction. The guard 33 may extend in the longitudinal direction of the substrate 32, namely, in the left-right direction. The side part 83 and the rear part 81 may be elongated laterally along the longitudinal direction of the substrate 32. A plurality of heat dissipation holes 74 may be arranged to be spaced apart from each other in the left-right direction.

The source PCB 12 and the board P (see FIG. 5) may be positioned on the heat dissipation space 75. A shield plate 120 may be disposed at the rear of the plurality of source PCBs 12 (see FIG. 5), and may be detachably coupled to the frame 60. The shield plate 120 may cover the rear of the plurality of source PCBs 12. The shield plate 120 may be positioned in the heat dissipation space 75.

The first cable 11 may be positioned between the guide panel 13 and the front cover 15. One end of the first cable 11 may be connected to a lower edge of the display panel 10 between the horizontal portion 131 of the guide panel 13 and the second part 151 of the front cover 15. The first cable 11 may be bent rearward from the edge of the display panel 10, and may pass between the vertical portion 133 of the guide panel 13 and the first part 153 of the front cover 15. The other end of the first cable 11 may be connected to the source PCB 12 at the rear of the frame 60.

A plurality of first cables 11 may be arranged to be spaced apart from each other in the left-right direction. Each of the plurality of first cables 11 may be connected to a respective one of the plurality of source PCBs 12 (see FIG. 5) that are spaced apart from each other in the left-right direction.

The heat dissipation fin 85 may protrude rearward from the second rear part 81B (see FIG. 9). The source PCB 12 may be disposed at a position corresponding to the first rear part 81A (see FIG. 9). The heat dissipation fin 85 may be disposed above the source PCB 12. The source PCB 12 may be disposed between the heat dissipation hole 74 and the heat dissipation fin 85. The source PCB 12 may be closer to the vertical portion 63 than the heat dissipation fin 85, allowing the first cable 11 to be connected to the source PCB 12 without being caught on the heat dissipation fin 85.

A speaker 90 may be disposed between the frame 60 and the back cover 70. The speaker 90 may be disposed at the rear of the heat dissipation plate 80 and the frame 60. The heat dissipation fin 85 may be spaced forward from the speaker 90. The speaker 90 may be exposed to the heat dissipation space 75, thereby allowing heat to be discharged into the heat dissipation space 75.

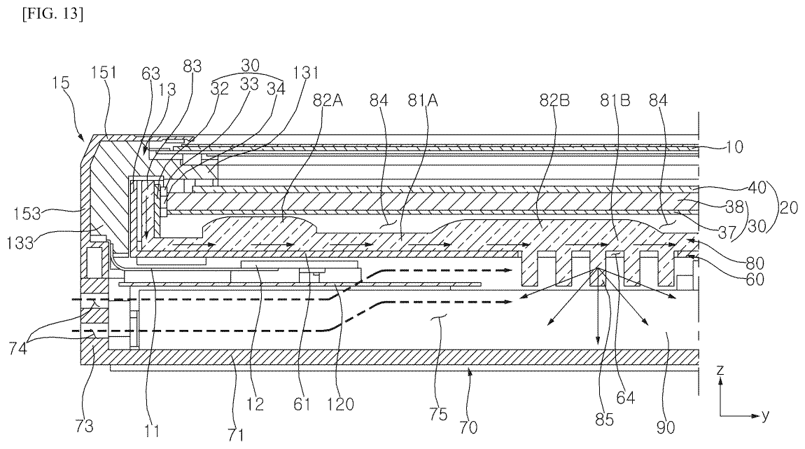

Referring to FIG. 13, heat generated from the substrate 32 may be transferred to the side part 83 of the heat dissipation plate 80 and then distributed to the rear part 81 and the heat dissipation fin 85 to be dissipated. As the heat dissipation fin 85 is exposed to the heat dissipation space 75, heat in the substrate 32 may be efficiently dissipated through heat exchange with outside air. The heat transferred from the substrate 32 to the rear part 81 may be conducted to the plate portion 61 of the frame 60 and discharged into the heat dissipation space 75. The source PCB 12 may dissipate heat into the heat dissipation space 75. The board P (see FIG. 5) may dissipate heat into the heat dissipation space 75. The speaker 90 may dissipate heat into the heat dissipation space 75. Air may circulate in and out of the heat dissipation space 75 through the heat dissipation hole 74, thereby cooling the rear part 81, the heat dissipation fin 85, the source PCB 12, and the board P.

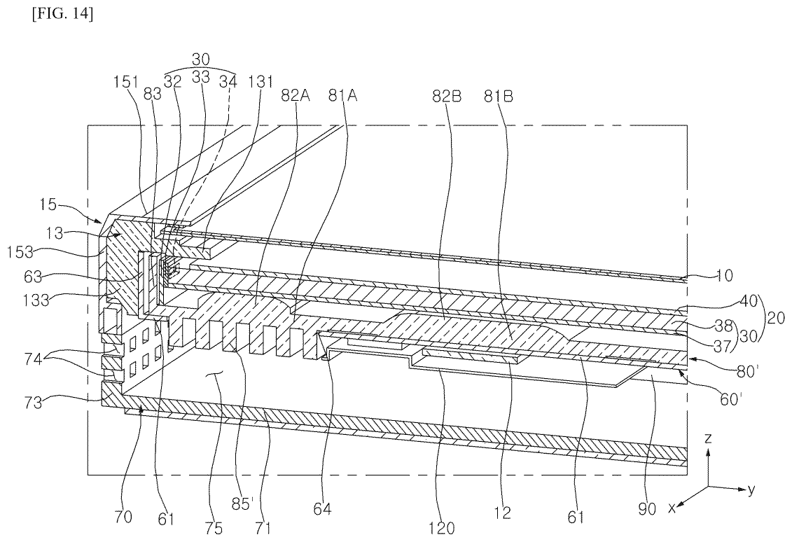

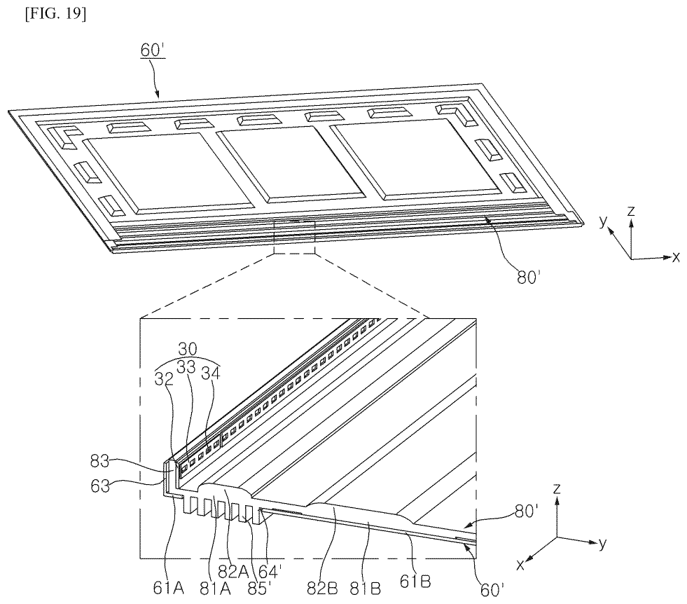

Hereinafter, with reference to FIGS. 14 to 20, differences from the embodiments of FIGS. 6 to 13 will be mainly described.

Referring to FIG. 14, a heat dissipation fin 85′ may protrude rearward from a heat dissipation plate 80′. The heat dissipation fin 85′ may be exposed to the heat dissipation space 75 by passing through a second slit 64′ formed in a frame 60′. The heat dissipation fin 85′ may be positioned between the heat dissipation hole 74 and the source PCB 12. The heat dissipation fin 85′ may be closer to the heat dissipation hole 74 than to the source PCB 12.

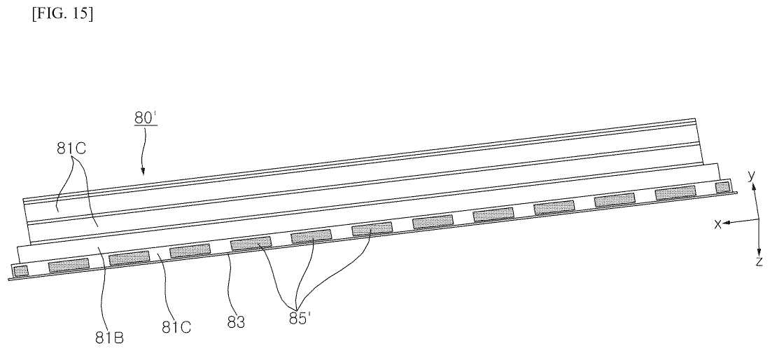

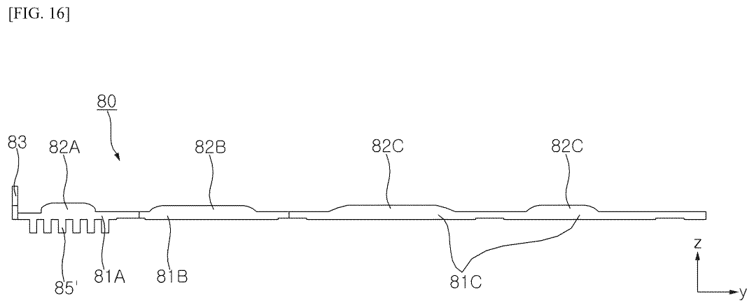

Referring to FIGS. 15 and 16, the heat dissipation fin 85′ may protrude rearward from a first rear part 81A of the heat dissipation plate 60′. The heat dissipation fin 85′ and the first protruding portion 82A may be opposite each other with respect to the first rear part 81A. The heat dissipation fin 85′ may be adjacent to the side part 83. A plurality of heat dissipation fins 85′ may be arranged to be spaced apart from each other in the left-right direction.

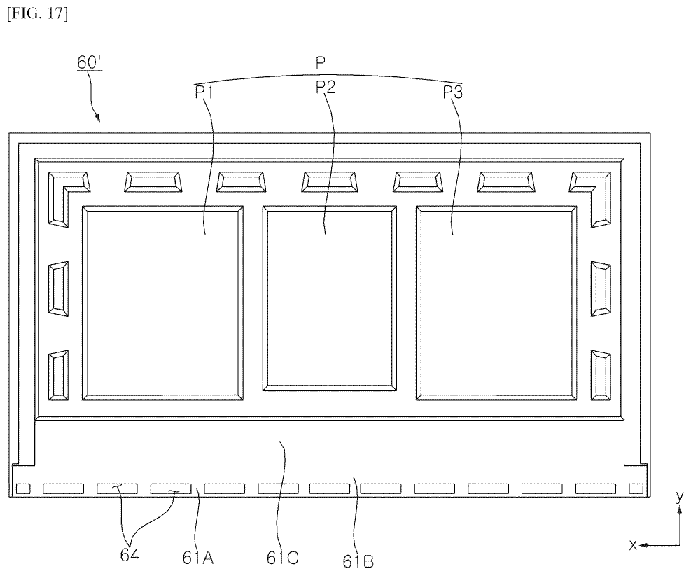

Referring to FIGS. 17 to 19, the second slit 64′ may be formed in the frame 60′ at a position corresponding to the heat dissipation fin 85′. Each of the plurality of heat dissipation fins 85′ may pass rearward through a respective one of a plurality of second slits 64′. The heat dissipation fins 85′ may be disposed below the source PCB 12.

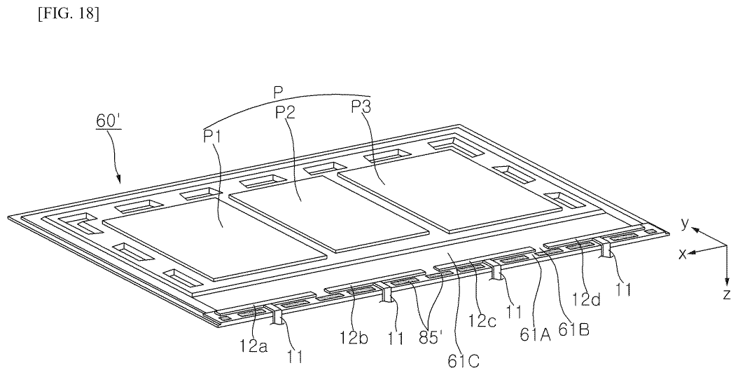

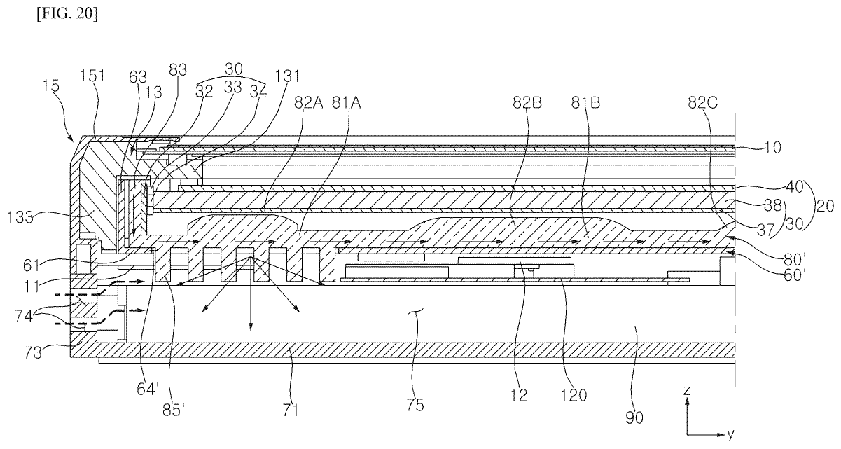

Referring to FIG. 18 and FIG. 20, the heat dissipation fin 85′ may be positioned between the heat dissipation hole 74 and the source PCB 12. The heat dissipation fin 85′ may be closer to the heat dissipation hole 74 than to the source PCB 12. Accordingly, it is possible to increase the heat exchange efficiency of the heat dissipation fin 85′ with outside air introduced from the heat dissipation hole 74. As the plurality of heat dissipation fins 85′ are spaced apart from each other in the left-right direction, the plurality of first cables 11 may be connected to the source PCB 12 by passing between the plurality of heat dissipation fins 85′.

Referring to FIGS. 1 to 20, a display device according to an aspect of the present disclosure may include: a display panel; a light guide plate positioned behind the display panel; a light assembly configured to provide light to one side of the light guide plate; a substrate on which the light assembly is mounted; and a heat dissipation plate including a rear part that is disposed on a rear surface of the light guide plate, and a side part that is bent forward from one side of the rear part to cover one side of the light guide plate, the substrate is coupled to the side part. The heat dissipation plate may include a heat dissipation fin protruding rearward from the rear part.

The display device may further include a frame positioned at a rear of the heat dissipation plate, and the display panel is coupled to the frame.

The frame may include a slit through which the heat dissipation fin passes rearward.

The display device may further include a back cover to cover a rear of the frame. A heat dissipation passage to which the heat dissipation fin is exposed may be formed between a front surface of the back cover and a rear surface of the frame, and a heat dissipation hole through which the heat dissipation passage communicates with an outside of the display device may be formed in the back cover.

The heat dissipation hole may be formed on one side of the back cover at a position adjacent to the heat dissipation plate and may be open toward the heat dissipation fin.

The substrate may be extended along the one side of the light guide plate. The side part, the rear part, and the heat dissipation fin may be extended along a longitudinal direction of the substrate.

The heat dissipation hole may be provided in plurality arranged along a longitudinal direction of the heat dissipation fin.

The display device may further include: a board mounted on the rear surface of the frame; and a source PCB disposed on the rear surface of the frame and electrically connected to the display panel and the board.

The source PCB may be disposed between the heat dissipation hole and the heat dissipation fin.

The heat dissipation fin may be adjacent to the heat dissipation hole and may be disposed between the heat dissipation hole and the source PCB.

The display device may further include: a guide panel extending along a periphery of the frame and covering a rear surface of the display panel adjacent to a periphery of the display panel; a front cover extending along the periphery of the display panel and covering a front surface of the display panel adjacent to the periphery of the display panel; first cables passing between the guide panel and the front cover and configured to electrically connect the display panel and the source PCB; and second cables to electrically connect the source PCB and the board.

The heat dissipation fin and the slit may be provided as a plurality of heat dissipation fins and slits arranged along a longitudinal direction of the substrate and spaced apart from each other. The first cables may pass between the plurality of heat dissipation fins.

A rear surface of the rear part of the heat dissipation plate may be in contact with a front surface of the frame.

The display device may further include a speaker disposed on the heat dissipation passage at the front surface of the back cover.

Certain embodiments or other embodiments of the disclosure described above are not mutually exclusive or distinct from each other. Any or all elements of the embodiments of the disclosure described above may be combined or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

The above detailed description is to be construed in all aspects as illustrative and not restrictive. The scope of the present disclosure should be determined by reasonable interpretation of the appended claims, and all changes coming within the equivalency range of the present disclosure are intended to be embraced in the scope of the present disclosure.

1. A display device comprising:
a display panel;
a light guide plate positioned behind the display panel;
a light assembly configured to provide light to one side of the light guide plate;
a substrate on which the light assembly is mounted; and
a heat dissipation plate including a rear part that is disposed on a rear surface of the light guide plate, and a side part that is bent forward from one side of the rear part to cover one side of the light guide plate, the substrate is coupled to the side part,
wherein the heat dissipation plate includes a heat dissipation fin protruding rearward from the rear part.

2. The display device of claim 1, further comprising a frame positioned at a rear of the heat dissipation plate, and the display panel is coupled to the fame.

3. The display device of claim 2, wherein the frame includes a slit through which the heat dissipation fin passes rearward.

4. The display device of claim 3, further comprising a back cover to cover a rear of the frame,
wherein a heat dissipation passage to which the heat dissipation fin is exposed is formed between a front surface of the back cover and a rear surface of the frame, and a heat dissipation hole through which the heat dissipation passage communicates with an outside of the display device is formed in the back cover.

5. The display device of claim 4, wherein the heat dissipation hole is formed on one side of the back cover at a position adjacent to the heat dissipation plate, and is open toward the heat dissipation fin.

6. The display device of claim 5, wherein the substrate is extended along the one side of the light guide plate, and
wherein the side part, the rear part, and the heat dissipation fin are extended along a longitudinal direction of the substrate.

7. The display device of claim 6, wherein the heat dissipation hole is provided in plurality arranged along a longitudinal direction of the heat dissipation fin.

8. The display device of claim 4, further comprising:
a board mounted on the rear surface of the frame; and
a source PCB disposed on the rear surface of the frame and electrically connected to the display panel and the board.

9. The display device of claim 8, wherein the source PCB is disposed between the heat dissipation hole and the heat dissipation fin.

10. The display device of claim 8, wherein the heat dissipation fin is adjacent to the heat dissipation hole, and is disposed between the heat dissipation hole and the source PCB.

11. The display device of claim 10, further comprising:
a guide panel extending along a periphery of the frame and covering a rear surface of the display panel adjacent to a periphery of the display panel;
a front cover extending along the periphery of the display panel and covering a front surface of the display panel adjacent to the periphery of the display panel;
first cables passing between the guide panel and the front cover and configured to electrically connect the display panel and the source PCB; and
second cables to electrically connect the source PCB and the board.

12. The display device of claim 11, wherein the heat dissipation fin and the slit are provided as a plurality of heat dissipation fins and slits arranged along a longitudinal direction of the substrate and spaced apart from each other, and wherein the first cables pass between the plurality of heat dissipation fins.

13. The display device of claim 2, wherein a rear surface of the rear part of the heat dissipation plate is in contact with a front surface of the frame.

14. The display device of claim 4, further comprising a speaker disposed on the heat dissipation passage at the front surface of the back cover.
